(19) United States
(12) Patent Application Publication
(10) Pub. No.: US 2024/0246051 A1
(43) Pub. Date: Jul. 25, 2024

(54) VESSELS FOR PROCESSING POLYMER PARTICULATES AND METHODS FOR OPERATING THE SAME

(71) Applicant: Dow Global Technologies LLC, Midland, MI (US)

(72) Inventors: Shrikant Dhodapkar, Lake Jackson, TX (US); Yu Liu, Lake Jackson, TX (US); Ivan A. Konstantinov, Manvel, TX (US)

(73) Assignee: Dow Global Technologies LLC, Midland, MI (US)

(21) Appl. No.: 18/693,415

(22) PCT Filed: Sep. 16, 2022
(86) PCT No.: PCT/US2022/043764

§ 371 Date: Mar. 19, 2024

Related U.S. Application Data
(60) Provisional application No. 63/246,554, filed on Sep. 21, 2021.

(51) Int. Cl. B01J 8/12; B01J 8/00

(52) U.S. Cl. CPC B01J 8/125; B01J 8/003; B01J 8/0065; B01J 2208/00929

(57) ABSTRACT

A vessel for storing and/or processing polymer particulates includes main outer walls defining an upper end, a lower end, and a main interior space, a frustum-shaped outlet region positioned below the lower end of the main outer walls, a plurality of internal frustum sections positioned within the main outer walls, where a lower portion of each internal frustum section defines a passage extending through each of the plurality of internal frustum sections, an internal member including an internal member wall defining an internal member interior space separated from the main interior space, the internal member positioned within the main outer walls and extending from the upper end to the lower end of the main outer walls, the internal member extending through each passage of the plurality of internal frustum sections, and a purge gas source in communication with the internal member inner space.

### CROSS-REFERENCE TO RELATED APPLICATIONS

The present application claims priority to U.S. Provisional Patent Application No. 63/246,554, filed Sep. 21, 2021, and entitled “VESSELS FOR PROCESSING POLYMER PARTICULATES AND METHODS FOR OPERATING THE SAME,” the entirety of which is incorporated by reference herein.

### FIELD

The present disclosure generally relates to vessels for processing polymer particulates, and methods for operating the same.

### BACKGROUND

Silo degassers are commonly used to reduce the concentration of residual solvent from polymer particulate materials. This operation is generally performed by purging the bed of polymer particulates (in a silo) with gas. The polymer particulates can be heated with the purge gas itself, or an external heater at the inlet may provide heat. Since the degassing process is based, generally, on diffusion, where higher temperature yields a higher solvent removal rate, hence lower degassing time. Silo degassers have been extensively used in the industry for polypropylene (PP), low density polyethylene (LDPE), linear low density polyethylene (LLDPE), high density polyethylene (HDPE) and polystyrene (PS) applications where the particulates are essentially free-flowing at degasser operating temperatures.

### SUMMARY

Particulate process applications, such as reactions, heating, and cooling, require uniform distribution of process gas within mass of particulates which can be at elevated temperatures. The purge gas can be a reactant or diluent or heat transfer fluid. Certain polymer particulates exhibit increased cohesion and reduced flowability with an increase in temperature. For reliable operation of such processes, it is imperative to design the process vessels to negate the consequences of increased cohesion and reduced flowability.

In particular, problems may arise in degassing procedures when polymer particulates do not freely flow through the degassing vessel, sometimes called blocking or bridging or arching. For example, lack of free flow of particulates may be a result of relatively high temperature conditions during degassing. Additionally, some polymeric materials (e.g., elastomers and ethylene co-polymers) may be particularly problematic since they may not flow freely when exposed to temperatures that do not cause other materials to block. However, running the degassing at lower temperatures is undesirable, since it results in a relatively inefficient process with a direct impact on production rate and capital intensity. Additionally, unplugging of process vessels results in significant downtime and wastage of prime products. Moreover, continuous circulation of the particulates, in an attempt to reduce blocking, causes degradation of the particulates.

According to the embodiments described herein, polymer particulate blockage may be reduced. It has been discovered that the use of an internal member positioned within the vessel walls along with frustums may reduce blocking of polymer particulates. It is believed that the introduction of the internal member may increase interparticle shear by reducing plug-flow type movement of the particulates near the center of the vessel within the cylindrical section of the process vessel. In one or more embodiments, the internal member may be extended continuously through the height of the vessel and passing through multiple internal frustum sections, as is explained in detail herein. Such embodiments may allow for higher temperature degassing (or processing) of polymeric materials and, with problematic polymeric materials, may allow for degassing at temperatures necessary for efficient degassing (or processing).

In one embodiment, a vessel for storing polymer particulates includes main outer walls defining an upper end, a lower end, and a main interior space, a frustum-shaped outlet region positioned below the lower end of the main outer walls, a plurality of internal frustum sections positioned within the main outer walls, where an upper portion of each internal frustum section contacts the main outer walls, and where a lower portion of each internal frustum section defines a passage extending through each of the plurality of internal frustum sections, an internal member including an internal member wall defining an internal member interior space separated from the main interior space, the internal member positioned within the main outer walls and extending from the upper end to the lower end of the main outer walls, the internal member extending through each passage of the plurality of internal frustum sections, and a purge gas source in communication with the internal member inner space.

In another embodiment, a method for processing polymer particulates includes passing a plurality of polymer particulates through a main interior space defined by main outer walls defining an upper end and a lower end, passing the plurality of polymer particulates through an upper frustum section positioned within the main outer walls, the upper frustum section contacting the main outer walls and the upper frustum section defining an upper frustum passage extending through the upper frustum section, passing the plurality of polymer particulates through the upper frustum passage around an internal member positioned within the main outer walls and extending from the upper end to the lower end of the main outer walls, the internal member defining an internal member interior space separated from the main interior space, passing the plurality of polymer particulates through a lower frustum section positioned within the main outer walls, the lower frustum section contacting the main outer walls and the lower frustum section defining a lower frustum passage extending through the lower frustum section, and passing the plurality of polymer particulates through the lower frustum passage around the internal member, where the internal member extends through the upper frustum passage and the lower frustum passage.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts a section view of a vessel for processing polymer particulates, according to one or more embodiments described and depicted herein;

FIG. 2A schematically depicts a top view of an internal member of the vessel of FIG. 1, according to one or more embodiments described and depicted herein;

FIG. 2B schematically depicts a side view of the internal member of the vessel of FIG. 1, according to one or more embodiments described and depicted herein;

FIG. 3 schematically depicts a plurality of internal frustum sections of the vessel of FIG. 1, according to one or more embodiments described and depicted herein;

FIG. 4 schematically depicts a section view of another vessel for processing polymer particulates, according to one or more embodiments described and depicted herein; and

FIG. 5 schematically depicts a side view of additional embodiments of internal members, according to one or more embodiments described and depicted herein.

### DETAILED DESCRIPTION

Embodiments described herein are generally directed to vessels that include internal frustum sections and an internal member extending through the internal frustum sections. The internal frustum sections and the internal member may increase interparticle shear in polymer particulate passing through the vessel, thereby reducing blocking of the polymer particulate. Blocking refers to development of pellet-pellet bonding which manifests itself in increased cohesion, reduced flowability and/or caking of the bulk solids. By reducing the blocking of the polymer particulate, the process online time and process reliability will be increased. Significant downtime is incurred to remove blocked polymer particulates from the process vessels. For example, in instances in which the vessel is utilized for degassing the polymer particulate. These and other embodiments of vessels for processing polymer particulates are disclosed in greater detail herein with reference to the appended figures.

As referred to herein, the term “polymer particulate” refers to polymer matter in particulate form, for example and without limitation, polymer pellets, polymer granules, polymer powders and the like. Polymer particulates according to the present disclosure comprise at least 50 wt. % of polymeric material. In additional embodiments, the polymeric particulate may comprise at least 75 wt. %, at least 90 wt. %, at least 95 wt. %, at least 99 wt. %, at least 99.9 wt. % of polymeric material. In some embodiments, the polymer particulate may consist of polymeric material. In some embodiments, the polymer particulates comprise elastomers and ethylene co-polymers.

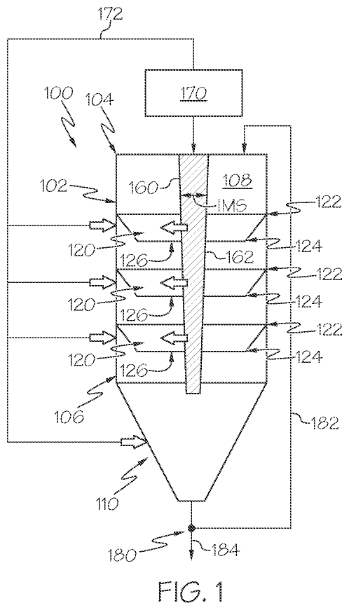

Referring initially to FIG. 1, an example vessel 100 for processing polymer particulates is schematically depicted. In embodiments, the vessel 100 includes main outer walls 102 defining an upper end 104 and a lower end 106. The upper end 104 and the lower end 106 are positioned opposite one another, for example, in a vertical direction. The main outer walls 102 define a main interior space 108 in which polymer particulate can be positioned. In the embodiment depicted in FIG. 1, the main outer walls 102 have a generally circular-shaped cross-section, however, it should be understood that this is merely an example. In embodiments, the main outer walls 102 may have any suitable shape for holding polymer particulates, and may form a rectangular-shaped cross-section and/or the like.

The vessel 100 includes a frustum-shaped outlet region 110 positioned below the lower end 106 of the main outer walls 102. In operation, polymer particulate may pass from the lower end 106 of the main outer walls 102 to the frustum-shaped outlet region 110, and may pass out of the vessel 100 through the frustum-shaped outlet region 110, for example as the result of gravity. In some embodiments, upon passing out the frustum-shaped outlet region 110, the polymer particulate may be re-introduced to the upper end 104 of the main outer walls 102. For example, in embodiments in which the vessel 100 is utilized in a degassing process, polymer particulate may be intermittently or continuously recycled through the vessel (i.e., passed out the frustum-shaped outlet region 110 and re-introduced to the upper end 104 of the main outer walls 102) until the degassing process is complete. In some embodiments, the polymer particulate may pass to another vessel or process upon exiting the frustum-shaped outlet region 110. In some embodiments, the polymer particulate may be temporarily stored within the vessel 100 and may not exit through the frustum-shaped outlet region 100 for a configurable amount of time.

For example, in the embodiment depicted in FIG. 1, the vessel 100 includes an outlet valve 180, a return conduit 182, and an outlet conduit 184. The return conduit 182, in embodiments, is in communication with the frustrum-shaped outlet region 110 and the upper end 104 of the main outer walls 102 such that polymer particulate can flow from the frustum-shaped outlet region 110, through the return conduit 182, to the upper end 104 of the main outer walls 102.

In operation, the outlet valve 180 is positionable at least between a return position and an outlet position. In the return position, the outlet valve 180 allows polymer particulate to pass through the outlet valve 180, through the return conduit 182, to the upper end 104 of the main outer walls 102, while restricting the flow of polymer particulate through the outlet valve 180 to the outlet conduit 184. Accordingly, polymer particulate can be re-introduced to the upper end 104 of the main outer walls 102 with the outlet valve 180 in the return position. In the outlet position, the outlet valve 180 allows polymer particulate to pass through the outlet valve 180 and through the outlet conduit 184, while restricting the flow of polymer particulate through the return conduit 182 to the upper end 104 of the main outer walls 102. Accordingly, polymer particulate can be passed out of the vessel 100 with the outlet valve 180 in the outlet position. In some embodiments, the outlet valve 180 is positionable in a closed position, in which the outlet valve 180 restricts the flow of polymer particulate to the return conduit 182 and the outlet conduit 184 through the outlet valve 180. Accordingly, with the outlet valve 180 in the closed position, polymer particulate can be maintained within the vessel 100.

In embodiments, the vessel 100 includes a plurality of internal frustum sections 120 positioned within the main outer walls 102. While in the embodiment depicted in FIG. 1, the vessel 100 includes three internal frustum sections 120, it should be understood that this is merely an example, and the plurality of internal frustum sections 120 may include any suitable number of frustum sections. In embodiments, an upper portion 122 of each internal frustum section 120 contacts the main outer walls 102. In some embodiments, at least a part of the upper portion 122 of each of the internal frustum sections 120 is coupled to the main outer walls 102, for example, through welding, brazing, structural adhesives, mechanical fasteners, and/or the like. In embodiments, a lower portion of 124 each internal frustum section 120 defines a passage 126 extending through each of the plurality of internal frustum sections 120. In operation, polymer particulate generally passes through the upper portion 122 of each of the internal frustum sections 120, and exits each of the internal frustum sections 120 through the passage 126 of each of the internal frustum sections 120.

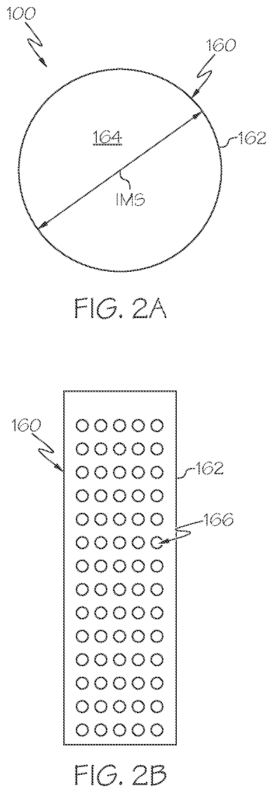

The vessel 100, in embodiments, includes an internal member 160. In particular and referring to FIGS. 1, 2A, and 2B, a top view and a side view of the internal member 160 are schematically depicted. In embodiments, the internal member 160 includes an internal member wall 162 defining an internal member interior space 164 separated from the main interior space 108. The internal member 160 is positioned within the main outer walls 102 and extends from the upper end 104 to the lower end 106 of the main outer walls 102. For example, in the embodiment depicted in FIG. 1, the internal member 160 extends through the entire height of the main outer walls 102 evaluated in the vertical direction. In embodiments, the internal member 160 extends through each passage 126 of the plurality of internal frustum sections 120 (i.e., through each passage 126 of each internal frustum section 120).

In some embodiments, the internal member wall 162 defines one or more internal member purge gas apertures 166 penetrating through the internal member wall 162. In operation, a purge gas can pass from the internal member interior space 164 out the one or more internal member purge gas apertures 166 to the main interior space 108. It should be understood that the size of the one or more internal member purge gas apertures 166 shown in FIG. 2B are merely illustrative, and in embodiments, the size of the one or more internal member purge gas apertures 166 may be selected to permit the passage of purge gas through the one or more internal member purge gas apertures 166, while restricting the passage of polymer particulate through the one or more internal member purge gas apertures 166. By selecting the size of the internal member purge gas apertures 166 to be large enough for purge gas to pass while restricting the passage of polymer particulates, purge gas may be passed from the internal member interior space 164 to the main interior space 108, while polymer particulate within the main interior space 108 is restricted from passing to the internal member interior space 164. While in the embodiment depicted in FIG. 2B the one or more internal member purge gas apertures 166 are depicted as having a generally circular shape, it should be understood that this is merely an example, and the one or more internal member purge gas apertures 166 may have any suitable shape. In some embodiments, the lower end of the internal member 160 is at least partially closed such that purge gas passed through the internal member interior space 164 exits the internal member 160 through the internal member purge gas apertures 166.

In some embodiments and as shown in FIG. 1, the internal member 160 is in communication with a purge gas source 170. The purge gas source 170, in embodiments, supplies the purge gas to the internal member interior space 164 and/or to the main interior space 108, as described in greater detail herein, and may include a fan, a pump, or the like to pass the purge gas to the internal member interior space 164 and/or the main interior space 108. The bottom of the internal member 160 may be closed so that no gas can escape.

In some embodiments, the purge gas source 170 may pass purge gas though pipe 172 to one or more purge gas apertures (depicted as arrows in FIG. 1) that through the outer walls 102 and into the interior space 108. Purge gas apertures may be located proximate the one or more internal frustum sections 120 and/or the frustum-shaped outlet region 110

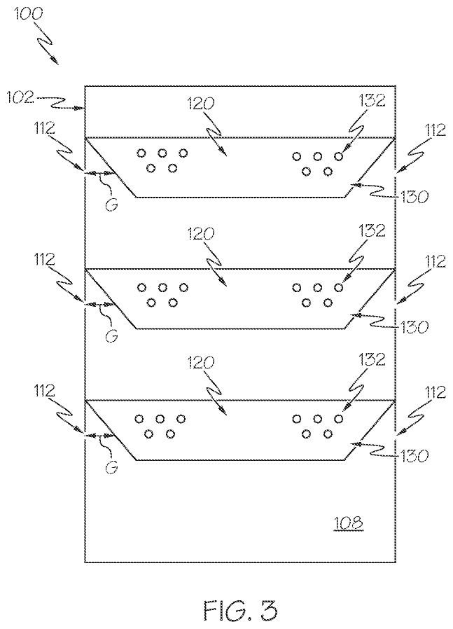

In some embodiments and as shown in FIG. 1, the internal member 160 defines an Internal Member Span “IMS.” In embodiments in which the internal member 160 has a cylindrical shape, the internal member span IMS is a diameter of the internal member 160. For example, FIG. 3A depicts an IMS where the internal member 160 has a circular cross-section. In the embodiment depicted in FIG. 1, the internal member 160 comprises a vertical taper such that the internal member span IMS changes moving along the internal member 160 in the vertical direction. In particular, in the embodiment depicted in FIG. 1, the internal member 160 includes a taper such that the internal member span IMS is less at the lower end of the internal member 160 than at the upper end. However, it should be understood that this is merely an example, and in some embodiments, the taper may be such that the internal member span IMS is greater at the lower end of the internal member 160 than at the upper end. Further, while in the embodiment depicted in FIG. 1 the taper is depicted as being linear, it should be understood that this is merely an example, and in embodiments, the internal member 160 may include a step-wise taper, a parabolic taper, or any other suitably shaped taper, or without any taper.

In one or more embodiments, the span of the outlet of the passage 126 of one or more of the internal frustum sections 120 may be defined as the internal frustum section outlet span. In the embodiment of FIG. 1, the outlet of an internal frustum section 120 is at the lower portion 124 (i.e., the bottom) of the passage 126 through the internal frustum section 120 since the solids move from top to bottom due to gravity. The span of the outlet of the internal frustum section 120 is determined similar to that of the internal member where, for example, a circular outlet has a span of the diameter of the outlet. Where the outlet is not circular, the average of the diagonals of the outlet measures the span. The ratio of the IMS (at a corresponding height to an internal frustum section 120) to the internal frustum section outlet span to may be from 0.15 to 0.85, such as from 0.15 to 0.65, or from 0.15 to 0.45. In some embodiments, the ratio of the IMS at each corresponding height to each internal frustum section outlet span may be from 0.15 to 0.85, such as from 0.15 to 0.65, or from 0.15 to 0.45. These described ratios may provide good balance between minimizing the IMS (so as to not take up as much space) and maximizing the IMS, which may promote non-plug flow regimes within the main interior space 108.

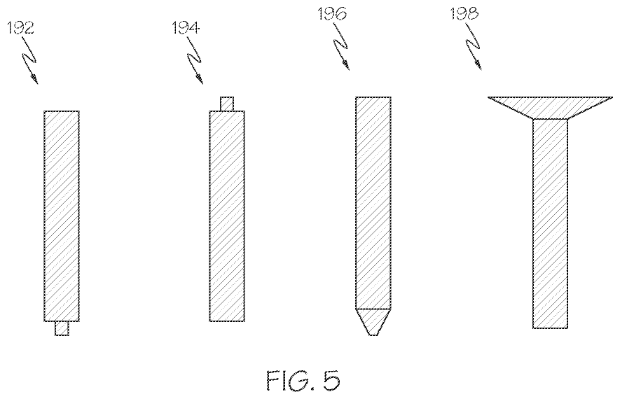

Now referring to FIG. 5, several additional embodiments of internal members 160 are depicted. Internal member 192 has a top section with constant IMS and a bottom section with constant IMS which is less than the top section. Internal member 194 has a top section with constant IMS and a bottom section with constant IMS which is greater than the top section. Internal member 196 has a top section with constant IMS and a bottom section with a frustum shaping having reduced IMS compared to the top section. Internal member 198 has a bottom section with constant IMS and a top section with a frustum shaping having increased IMS compared to the bottom section.

In some embodiments and referring to FIG. 3, the main outer walls 102 define one or more outer purge gas apertures 112 penetrating through the main outer walls 102. In operation, purge gas can pass through the one or more outer purge gas apertures 112 to the main interior space 108. In some embodiments, the one or more outer purge gas apertures 112 are in communication with a gap “G” positioned radially between the plurality of internal frustum sections 120 and the main outer walls 102. As polymer particulate passes through the main interior space 108, the gap G may generally have little or no polymer particulate. Accordingly, by passing the purge gas through the one or more outer purge gas apertures 112 to the gap G, the purge gas can be introduced into the main interior space 108 with minimal interference from the polymer particulate.

In embodiments and as shown in FIG. 3, the plurality of internal frustum sections 120 each define a frustum wall 130 extending from the upper portion 122 (FIG. 1) to the lower portion 124 (FIG. 1) of the internal frustum sections 120, and each frustum wall 130 defines one or more frustum apertures 132 penetrating through the frustum wall 130. It should be understood that, while FIG. 3 does not depict an internal member 160 for convenience and clarity, the embodiment of FIG. 3 includes an internal member 160 as shown in FIG. 1. In some embodiments, the one or more frustum apertures 132 are sized to allow purge gas to pass through the one or more frustum apertures 132, while restricting the flow of polymer particulate through the one or more frustum apertures 132. By allowing purge gas to pass through the one or more frustum apertures 132, purge gas may penetrate the frustum walls of the internal frustum sections 120 to access polymer particulate positioned within the internal frustum sections 120. While in the embodiment depicted in FIG. 3 the one or more frustum apertures 132 are depicted as being circular apertures, it should be understood that this is merely an example, and the one or more frustum apertures 132 may have any suitable shape to allow purge gas to pass through the one or more frustum apertures 132.

In operation and referring to FIGS. 1-3, polymer particulate may pass from the upper end 104 of the main outer walls 102, through the internal frustum sections 120 and around the internal member 160, and out the frustum-shaped outlet region 110. In embodiments in which the vessel is used in a degassing process, purge gas may be introduced to the vessel 100 through the internal member 160 and/or through the main outer walls 102. Without being bound by theory, increasing the temperature of the purge gas can decrease the time required for degassing the polymer particulate. However, polymer particulates exhibit a tendency to “block” or “fuse” or “bond” at elevated temperatures if they are moving as a mass without interparticle shear. This may result in plugging or blockage within the vessel. The internal frustum sections 120 and the internal member 160, in combination, aid in contributing to interparticle shear, thereby reducing blocking within the vessel 100. Further, the internal frustum sections 120 and the internal member 160 may assist in inducing mass-flow within the vessel 100, reducing the presence of “dead regions” as may be found in configurations that induce funnel-flow of particulate. Further, by introducing purge gas through the main outer walls 102 and the internal member 160, purge gas may be more distributed throughout the vessel 100 as compared to conventional designs that only introduce purge gas at the bottom of a vessel. By distributing purge gas throughout the vessel 100, temperature gradient across the vessel 100 can be reduced and a greater amount of the polymer particulate within the vessel 100 can be exposed to the purge gas at inlet conditions, thereby reducing process time. By reducing blocking and increasing the exposure of polymer particulates to purge gas, degassing processing time can be reduced and may be accomplished with minimal re-cycling of the polymer particulates through the vessel, which can lead to degradation of the polymer particulates.

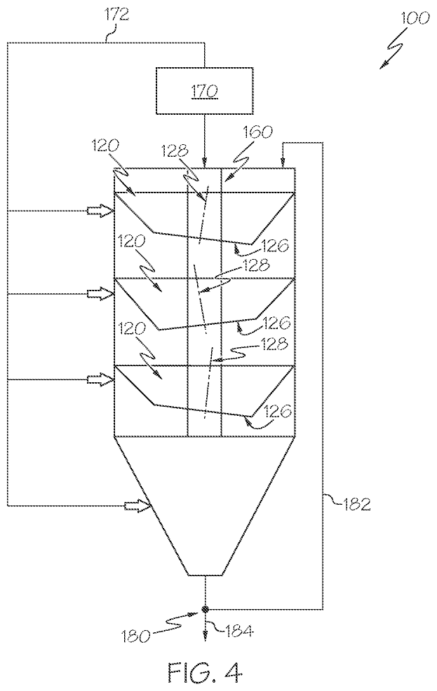

Referring to FIG. 4, in some embodiments, each of the plurality of internal frustum sections 120 defines a frustum centerline 128 that is generally perpendicular to the passage 126 of each of the plurality of internal frustum sections 120. In some embodiments, at least two of the frustum centerlines 128 of the plurality of frustum sections 120 are not collinear. For example, in the embodiment depicted in FIG. 4, each of the frustum centerlines 128 are oriented transverse to one another, however, it should be understood that this is merely an example. In some embodiments, at least two of the frustum centerlines 128 may be additionally or alternatively offset from one another in a radial direction. Because the frustum centerlines 128 are not collinear, the direction of flow of the polymer particulates is changed as the polymer particulates flow through each the internal frustum sections 120, which may further assist in reducing blocking of the polymer particulates.

It should now be understood that embodiments described herein are generally directed to vessels including internal frustum sections and an internal member extending through the internal frustum sections. The internal frustum sections and the internal member may increase interparticle shear in polymer particulate passing through the vessel, thereby reducing blocking of the polymer particulate. By reducing the blocking of the polymer particulate, process time can be reduced, for example, in instances in which the vessel is utilized for degassing the polymer particulate. Accordingly, embodiments described herein are designed to operate in mass flow to avoid stagnant regions within content of the vessel during discharge or recirculation.

It is noted that recitations herein of a component of the present disclosure being “structurally configured” in a particular way, to embody a particular property, or to function in a particular manner, are structural recitations, as opposed to recitations of intended use. More specifically, the references herein to the manner in which a component is “structurally configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A vessel for storing polymer particulates, the vessel comprising:
main outer walls defining an upper end, a lower end, and a main interior space;
a frustum-shaped outlet region positioned below the lower end of the main outer walls;
a plurality of internal frustum sections positioned within the main outer walls, wherein an upper portion of each internal frustum section contacts the main outer walls, and wherein a lower portion of each internal frustum section defines a passage extending through each of the plurality of internal frustum sections;
an internal member comprising an internal member wall defining an internal member interior space separated from the main interior space, the internal member positioned within the main outer walls and extending from the upper end to the lower end of the main outer walls, the internal member extending through each passage of the plurality of internal frustum sections; and
a purge gas source in communication with the internal member inner space.

2. The vessel of claim 1, wherein the plurality of internal frustum sections comprises more than two internal frustum sections.

3. The vessel of claim 1, wherein the internal member wall defines one or more internal member purge gas apertures penetrating through the internal member wall.

4. The vessel of claim 1, wherein the main outer walls define one or more outer purge gas apertures penetrating through the main outer walls, the one or more outer purge gas apertures in communication with a gap positioned radially between the plurality of internal frustum sections and the main outer walls.

5. The vessel of claim 1, wherein each of the plurality of frustum sections define a frustum centerline, and at least two of the frustum centerlines of the plurality of frustum sections are not collinear.

6. The vessel of claim 1, wherein the internal member defines an internal member span, and wherein the internal member comprises a vertical taper such that the internal member span changes moving along the internal member in a vertical direction.

7. The vessel of claim 1, wherein the internal member defines an internal member span, wherein the passage of each internal frustum section defines an internal frustum section outlet span, and wherein the ratio of the internal member span to the internal frustum section outlet span at one or more of the internal frustum sections is from 0.15 to 0.85.

8. The vessel of claim 1, wherein the plurality of internal frustum sections each defines a frustum wall extending from the upper portion to the lower portion of the internal frustum sections, and wherein each frustum wall defines one or more frustum apertures penetrating through the frustum wall.

9. A method for processing polymer particulates, the method comprising:
passing a plurality of polymer particulates through a main interior space defined by main outer walls defining an upper end and a lower end;
passing the plurality of polymer particulates through an upper frustum section positioned within the main outer walls, the upper frustum section contacting the main outer walls and the upper frustum section defining an upper frustum passage extending through the upper frustum section;
passing the plurality of polymer particulates through the upper frustum passage around an internal member positioned within the main outer walls and extending from the upper end to the lower end of the main outer walls, the internal member defining an internal member interior space separated from the main interior space;
passing the plurality of polymer particulates through a lower frustum section positioned within the main outer walls, the lower frustum section contacting the main outer walls and the lower frustum section defining a lower frustum passage extending through the lower frustum section; and
passing the plurality of polymer particulates through the lower frustum passage around the internal member, wherein the internal member extends through the upper frustum passage and the lower frustum passage.

10. The method of claim 9, further comprising passing a process gas to one or more of the main interior space or the internal member interior space, wherein passing the process gas to the interior space comprises passing the process gas from the internal member interior space through one or more internal member purge gas apertures penetrating through the internal member wall of the internal member into the main interior space.

11. The method of claim 9, further comprising passing a process gas to one or more of the main interior space or the internal member interior space, wherein passing the process gas to the interior space comprises passing the process gas through one or more outer purge gas apertures penetrating through the main outer walls into the main interior space.

12. The method of claim 11, wherein passing the process gas through the one or more outer purge gas apertures comprise passing the process gas to a gap positioned radially between the upper frustum section and the main outer walls.

13. The method of claim 1, wherein the polymer particulates comprise elastomers and ethylene co-polymers.

14. The method of claim 1, further comprising passing the plurality of polymer particulates out a frustum-shaped outlet region positioned below the lower end of the main outer walls and passing the plurality of polymer particulates from the frustum-shaped outlet region to the upper end of the main outer walls.

15. The method of claim 1, wherein the internal member defines an internal member span, wherein the upper frustum passage defines an internal frustum section outlet span, and wherein the ratio of the internal member span to the internal frustum section outlet span at the upper internal frustum section is from 0.15 to 0.85.
